(19) United States
(12) Patent Application Publication
(10) Pub. No.: US 2006/0209079 A1
(43) Pub. Date: Sep. 21, 2006

(54) Graphics controller providing for efficient pixel value transformation

(76) Inventors: Eric Jeffrey, Richmond (CA); Barinder Singh Rai, Surrey (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/081,901

(22) Filed: Mar. 16, 2005

(51) Int. Cl. G06F 13/14

(52) U.S. Cl. 345/520

(57) ABSTRACT

A graphics controller providing for efficient pixel value transformations. A graphics controller interfaces between a host and a graphics display device for displaying pixels having pixel values. The graphics controller includes a solarizing circuit having means for transforming an original pixel value to a transformed pixel value according to a transform function, said transform function having a negative slope at said original pixel value.

### FIELD OF THE INVENTION

The present invention relates to a graphics controller providing for efficient pixel value transformations, such as that known in the art as “solarizing.”

### BACKGROUND

In a graphics display system, such as a cellular telephone, a graphics controller is often provided for interfacing between one or more hosts, such as a central processing unit (“CPU”), digital signal processor (“DSP”), or camera, and a graphics display device, such as a liquid crystal display (“LCD”). While in principle the host may interface directly with the display device, provided that the host's read/write operations conform to the protocol specified for the display device, use of the graphics controller reduces the requirements on the host and increases system efficiency. The graphics controller is typically a separate, dedicated integrated circuit (“IC”), which provides specialized functions related to driving the graphics display device.

The functions of the graphics controller typically include JPEG encoding of outgoing image data for transmission and decoding of incoming image data for display, cropping or otherwise resizing images, and translating image data from one color space to another. In telephone and other systems used for data communications, graphics controllers are used for both wireless and wired communications.

The graphics controller also receives commands from the host and controls the graphics display device according to the commands, such as by enabling or disabling a particular display panel of a device and by specifying display parameters such as image size and color resolution.

Typically, the graphics controller includes an internal memory for storing image data received from a host. The internal memory includes a portion known as a “frame buffer” that is used for storing a “frame” of image data, i.e., all of the image data that is to be displayed as pixels by the graphics display device. The data are moved from the frame buffer to the display in a raster-scan order, the frame defining the image seen on the display. Often, the internal memory includes a “non-display” memory from which data are selected for storage in the frame buffer.

Graphics controllers are continually being improved to include more functions, and to enable the graphics display system to provide more functions without commensurately increasing the burden on the host. It is particularly important in inexpensive, battery powered, portable systems such as cellular telephones to minimize the processing overhead imposed on the host, and it is also important to minimize overall system power consumption in such systems.

One feature that has been provided in prior art graphics controllers is known as “solarization.” This term refers to a process used in film photography whereby the film is intentionally overexposed to create a double-exposed appearance. The term is also used to describe a digital simulation of this process, whereby a transfer function is established for transforming the value, typically the grey-scale value, of a pixel. In a typical solarization transfer function, pixels having grey-scale values below a certain threshold are not transformed, while pixels having grey-scale values above this level are transformed by decreasing their values linearly in proportion to the amount that their original, non-transformed values exceed the threshold.

The solarizing function has been provided in the prior art by having the host provide predetermined, discrete values of the function for all possible values of the pixels and store the values in a look-up table resident in the graphics controller, e.g., in its internal memory. The graphics controller then consults the look-up table for each pixel that is to be transmitted to the graphics display device and transmits the value determined by the look-up table.

There are a number of drawbacks of this approach. First, the approach requires additional host processing overhead. Second, the approach requires transmitting look-up table data from the host to the graphics controller over a bus which significantly increases power consumption. Third, consulting the look-up table within the graphics controller to acquire pixel values relies on memory fetches, a relatively slow process.

Kurashige, U.S. Patent Publication No. US 2002/0008783 and Gindele, U.S. Patent Publication No. US 2003/0234944 disclose the general concept of providing value transformations in image generating and image capturing apparatus. However, the '783 publication discloses no means for providing this function and the '944 publication appears to disclose a methodology that is the same as or similar to the prior art

Accordingly, there is a need for a graphics controller providing for efficient pixel value transformations, particularly for providing solarization transformations, that minimizes host overhead and power consumption.

### SUMMARY

A graphics controller providing for efficient pixel value transformations according to the present invention is disclosed. The graphics controller interfaces between a host and a graphics display device for displaying pixels having pixel values. The graphics controller includes a solarizing circuit having means for transforming an original pixel value to a transformed pixel value according to a transform function, the transform function having a negative slope at the original pixel value.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a block diagram of a graphics display system according to the present invention, showing a graphics controller for interfacing between a remote host and a remote graphics display device.

FIG. 2A is a functional diagram of a solarizing circuit according to the present invention, for use in the graphics controller of FIG. 1, for transforming an original pixel value to a transformed pixel value according to a solarization function where the solarization function has a negative slope at the original pixel value.

FIG. 2B is a functional diagram of the solarizing circuit of FIG. 2A further adapted for transforming the original pixel value to a transformed pixel value according to the solarization function where the solarization function has a positive slope at the original pixel value.

FIG. 2C is a functional diagram of a second exemplary solarizing circuit according to the present invention, corresponding to FIG. 2A.

FIG. 2D is a functional diagram of the solarizing circuit of FIG. 2C, corresponding to FIG. 2B.

FIG. 2E is a schematic diagram of a preferred solarizing circuit according to the present invention.

FIG. 3 is a plot of a solarizing function for transforming an original pixel value according to the present invention.

FIG. 4 is a plot of a solarizing function that generalizes the solarizing function of FIG. 3.

### DETAILED DESCRIPTION OF PREFERRED EMBODIMENTS

The invention is directed to a graphics controller providing for efficient pixel value transformations, such as that known in the art as “solarizing.” Reference will be made in detail below to preferred embodiments of the invention, examples of which are illustrated in accompanying drawings. Wherever possible, the same reference numbers are used in the drawings and the description to refer to the same or like parts.

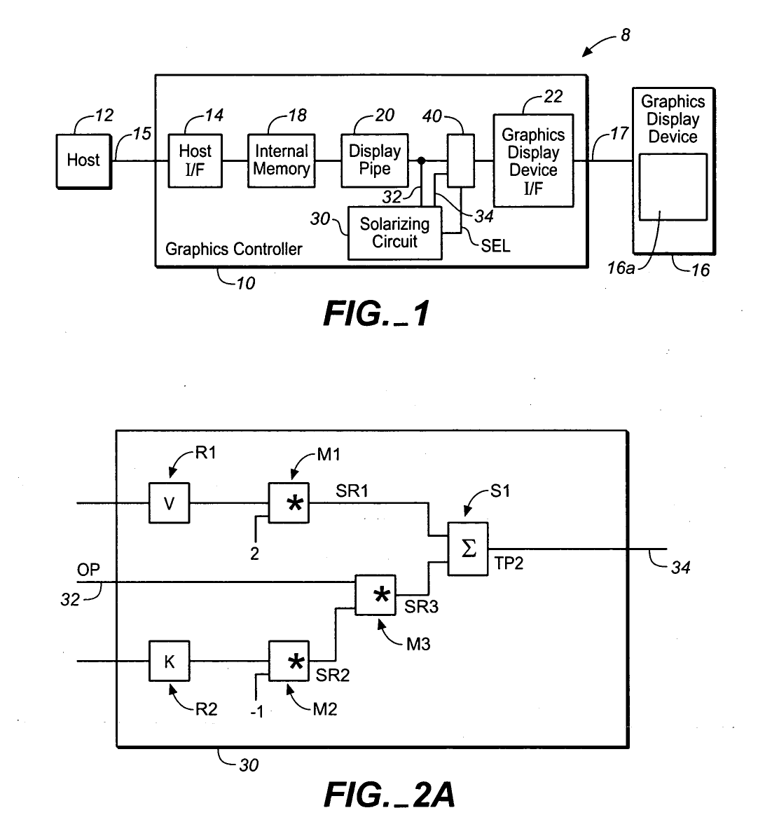

To provide context for the invention, FIG. 1 shows a graphics display system 8 which is preferably a cellular or mobile telephone but which may be any system providing for the display or rendering of digital image data in a visually perceptible form. The system includes a host 12, a graphics controller 10, and a graphics display device 16, the graphics controller 10 interfacing between the host and the graphics display device, which are both remote from the graphics controller. The graphics controller is preferably embodied in a single IC.

The host 12 is preferably a microprocessor, but may be a computer, a CPU, an MPU, a DSP, a camera or other image capture device, or any other provider of digital image data.

The graphics display device 16 is preferably an LCD panel, but any device(s) capable of rendering pixel data in visually perceivable form may be employed, such as CRT, LED, OLED, and plasma devices, without regard to the particular display technology employed. The display device may also be a hardcopy device, such as a printer or plotter. The graphics display device 16 has a graphics display area 16a for displaying pixels of image data transmitted to the graphics display device by the graphics controller 10.

As is typical in the art, the graphics controller 10 includes a host interface 14, an internal memory 18, a buffer or “display pipe” 20, and a graphics display device interface 22. The host interface 14 receives image data from the remote host over an input bus 15 and stores the image data in the internal memory 18 as defined by the host. The display pipe 20 functions as a FIFO buffer between the internal memory 18 and the display device 16 which generally have different timing requirements. The graphics display device interface 22 transmits the image data from the display pipe 20 to the remote display device 16 over an output bus 17.

According to the invention, the graphics controller 10 also includes a solarizing circuit 30, for producing a solarizing operation on image data bound for transmission to the display device 16. In the example shown, the solarizing circuit 30 receives the image data at an output 32 of the display pipe 20, but this is not essential. An optional selecting circuit 40 includes a multiplexer for selecting, for provision to the graphics display device 16, either the output 34 of the solarizing circuit 30 or the output 32 of the pipe 20 depending on the value of a select signal “SEL.” Alternatively and consistent with the preferred embodiment described below, the solarization circuit 30 may produce all of the output required for provision to the display device.

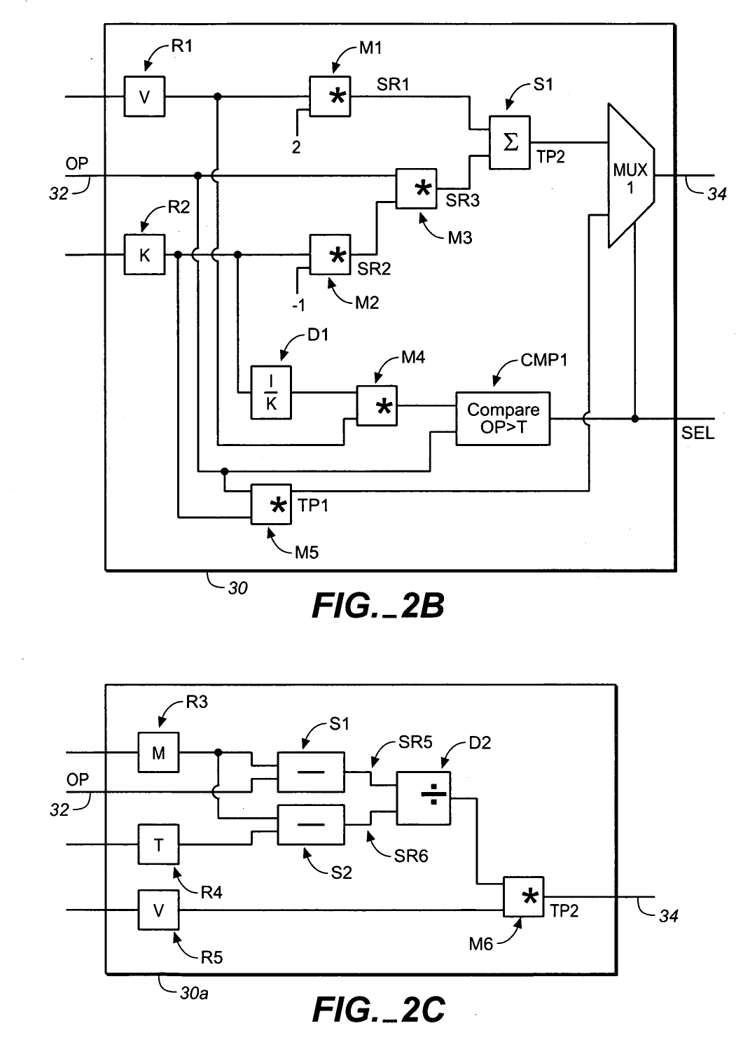

FIG. 2A shows a functional diagram of one embodiment of the solarizing circuit 30 in detail. The circuit 30 includes parametric registers “R1,” and “R2,” which may or may not be separate registers and which may or may not be distinct from the internal memory 18. Preferably, the host 12 writes parametric and control data, or causes parametric and control data to be written, to the parametric and control registers, respectively; however, this is not essential. The parametric registers are used to store parameters defining a desired solarizing function for implementation in the solarizing circuit 30.

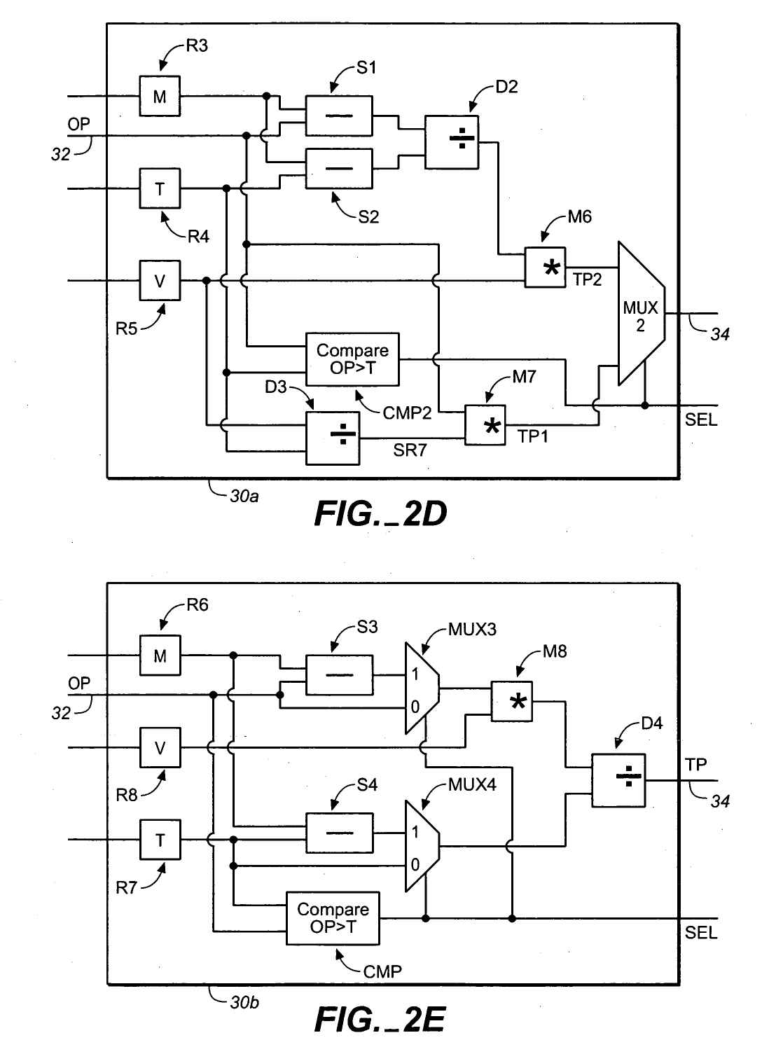

FIG. 3 shows an exemplary prior art solarizing function “F.” The function F may be defined with respect to two orthogonal axes “OP” (for “original pixel”) and “TP” (for “transformed pixel”) defining pixel “values.” Typically, a pixel is expressed as 24 bits comprising three component values. In an RGB model, a first 8 bits define the intensity of a first primary color (e.g., red), a second 8 bits define the intensity of a second primary color (e.g., green), and a third 8 bits define the intensity of a third primary color (e.g., blue). Accordingly, a color pixel may have three component values (for intensity), one for each primary color. Alternatively, a YUV model may be employed wherein a first component represents an 8 bit luminance value, and second and third components represent 8 bit color difference values. According to yet another alternative model, a pixel may be grey-scale and consist of only 8 bits, having only one such value. Operation of the solarizing circuit 30 is described herein for transforming one component value of a pixel, it being understood that the same or a similar methodology may be employed for transforming additional component values of the pixel.

The original pixel value OP is the value of the pixel that would ordinarily be provided to the graphics display device interface 22. The minimum value is zero, and the maximum value is M, e.g., 255 where the value is expressed by 8 bits.

The solarization function F is piecewise linear in two pieces. In a first piece of the solarization function, the solarization function increases linearly to a maximum value of V, corresponding to a threshold original pixel value of T. As the original pixel value increases beyond the threshold value T, the solarization function decreases linearly until it achieves a zero value for pixels having the maximum value M. In the exemplary solarizing function of FIG. 3, it is assumed that M=2T, i.e., that the solarizing function is symmetrical about its inflection point.

In the case of the solarizing function of FIG. 3, an original pixel P1 having an original pixel value OP1 that is less than T is transformed to a value TP1 that is proportional to OP1, i.e., (using the point-slope equation for a line Y=(M×X)+b):
TP1=K×OP1 (where K=V/T) Eqn. 1

In the simple case where K=1, TP1=OP1. This, essentially untransformed value can be provided by the solarization circuit 30, or would otherwise be normally provided without use of the circuit 30 and the circuit 30 may be advantageously modified to reduce or eliminate its power draw in this circumstance.

On the other hand, noting the equal distances indicated as “a” in FIG. 3, an original pixel P2 having an original pixel value OP2 that is greater than T is transformed to a value TP2 as follows:

$$\begin{matrix}TP 2 = V - ( TP {2}^{′} - V ) \\ = 2 V - TP {2}^{′}\end{matrix}$$

In the simple case where K=1, TP2′=OP2 and V=T, so
TP2=2T−OP2

In the more general case, TP2′=K×OP2, so that
TP2=2V−(K×OP2) Eqn. 2

As can be discerned by inspection, this expression defines a line intercepting the TP axis at a value 2V and having a slope equal to −K. For example, for V=T=128, an original pixel value OP2=200 has a transformed pixel value of 56 (i.e., 128−(200−128)).

Returning to FIG. 2A, a functional diagram of an embodiment of the solarizing circuit 30 for implementing equation 2 is shown. The circuit 30 receives the parameters V and K, e.g., from the host 12, multiplies the parameter V by a factor of two by use of a first multiplier M1 to produce a first result SR1, and multiplies the parameter K by a factor of minus one by use of a second multiplier M2 to produce a second result SR2. A third multiplier M3 multiplies the second result M2 by the pixel input value OP available from line 32 to produce a third result SR3. A summing module S1 sums the first result SR1 and the third result SR3 to produce the output TP2 on line 34.

The solarizing circuit 30 of FIG. 2A provides for transforming the original pixel according to the downward sloping portion of the solarizing function F. This functionality may be selected by any desired means, as indicated generally by the selection circuit 40 (FIG. 1).

The solarizing circuit 30 may be adapted to implement equation 1 by use of a multiplier M5 for multiplying the original pixel value OP by the value K stored in the register R2 to produce TP1. Referring to FIG. 2B, a functional diagram of a circuit 30 so adapted is shown. To select between TP1 and TP2, a comparator CMP1 determines whether the original pixel value OP is greater than the threshold T. The threshold T may be obtained by being provided to a register (not shown), or may be computed from V and K by use of the divider D1 (for forming the reciprocal of 1/K=T/V) and the multiplier M4 (for forming V×T/V). When the original pixel value OP exceeds the threshold T, the SEL signal is asserted. The select signal may be used to select TP1 or TP2 through use of a multiplexer MUX1 or may trigger the selection circuit 40. The latter option is most useful in conjunction with a “sleep” mode for the circuit 30 where K=1 (V=T), so that TP1 is equal to the original pixel value OP1 and there is no need to use the circuit 30 to transform the pixel value.

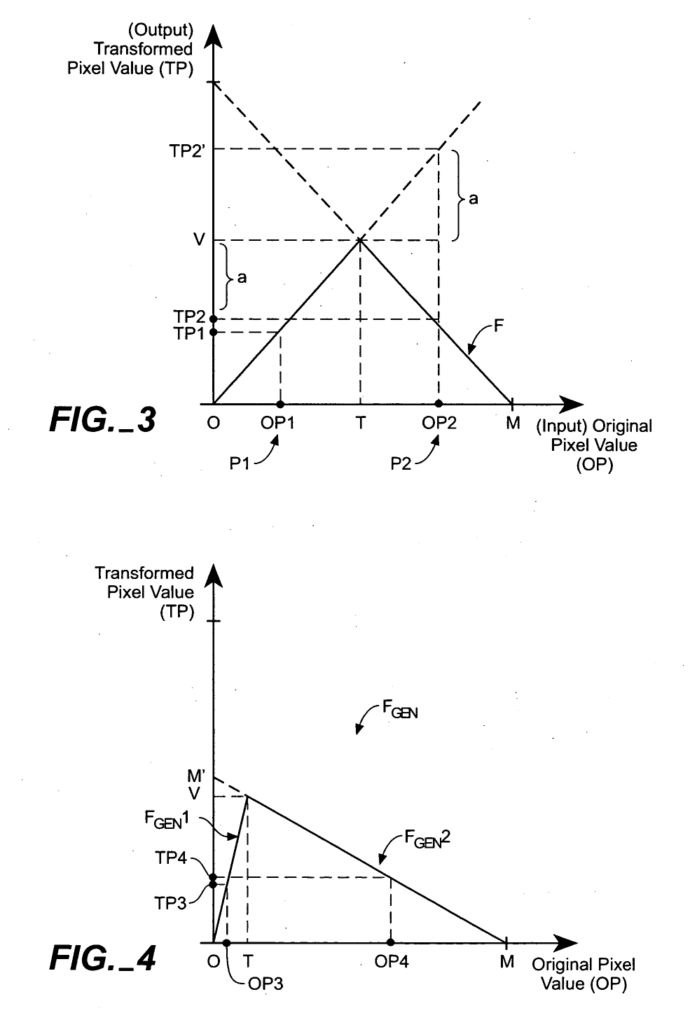

FIG. 4 shows a more general solarizing function F_{GEN}, for which T is not necessarily equal to M/2. The function F_{GEN} consists of two linear portions with different degrees of slope, namely, a positively sloped portion F_{GEN}1 and a negatively sloped portion F_{GEN}2. Equation 1 applies for transforming an original pixel value OP3 that is less than T into a transformed pixel value TP3 according to F_{GEN}1. For an original pixel value OP4 that is greater than T, the transformation is as follows according to the portion F_{GEN}2:

$$TP 4 = {M}^{′} - ( \frac{V}{( M - T )} \times OP 4 ) \\ TP 4 = V + ( \frac{T \times V}{( M - T )} ) - ( \frac{V}{( M - T )} \times OP 4 ) \\ TP 4 = V \times ( \frac{( M - OP 4 )}{( M - T )} ) \qquad Eqn 3$$

FIG. 2C shows a functional diagram of a solarizing circuit 30a for implementing equation 3. The quantities (M−OP2) and (M−T) are formed by use of subtraction modules S1 and S2 operating on the quantities M and T held in registers R3 and R4 to produce results SR5 and SR6, respectively. The result SR5 is divided by the result SR6 by use of a divider D2. The output of the divider D2 is finally multiplied by use of a multiplier M6 by the quantity V stored in the register R5 to produce the transformed pixel output TP2.

The solarizing circuit 30a may be adapted to implement equation 1 as shown in FIG. 2D where a divider D3 forms the result SR7 (=V/T) and a multiplier M7 forms the product of the result SR7 and the original pixel value OP to produce TP1. To select between TP1 and TP2, a comparator CMP2 determines whether the original pixel value OP is greater than the threshold T and, if so, selects TP2 by asserting the select signal SEL. The select signal may be used to select TP1 or TP2 through use of a multiplexer MUX2 or may trigger the selection circuit 40 (FIG. 1).

FIGS. 2A-2D illustrate the functions of the solarizing circuit examples 30 and 30a. Although the functions could be implemented as shown, a preferred implementation 30b providing an output for both the upward sloping and the downward sloping portions of the solarizing function F_{GEN} is shown in FIG. 2E. Registers R6, R7, and R8 receive parameters M, T, and V respectively. The original pixel input value is OP. A multiplexer MUX3 selects either the quantity (M−OP) or the quantity (OP), and a multiplexer MUX4 selects either the quantity (M−T) or the quantity T. A multiplier M8 forms either V·(M−OP) or V×OP, and a divider D4 produces a transformed output value TP that is either:

$$\frac{V}{T} \times ( OP ) ,$$

corresponding to the upward sloping portion of the function F_{GEN}1 or

$$V \times ( \frac{( M - OP )}{( M - T )} ) ,$$

corresponding to the downward sloping portion of the function F_{GEN}2 of the solarizing function. This implementation provides all of the above described functionality while minimizing circuit size and complexity.

Often, V=T in the solarizing function F and some simplification is possible in the solarizing circuits. For example, the divider D1 can be omitted from the circuit 30 shown in FIG. 2B because 1/K=K=1 if V=T. However, it is considered to be an advantage of the present invention that V can be specified independent of T. In addition, persons of ordinary skill will readily appreciate that the functionality of implementing a desired transformation function may be provided equivalently in numerous alternative circuit designs.

The functionality of the solarizing circuit 30 having been shown and described, additional ways to implement the solarizing circuit will be readily apparent to persons of ordinary skill.

Persons of ordinary skill in the art will readily appreciate that a circuit for implementing a desired transformation function according to the present invention can be implemented in a number of different ways. Preferably, such circuits are constructed according to traditional design methods using simple logic gates. More particularly, such circuits are preferably constructed by creating a source file in a hardware definition language such as VHDL or Verilog™. The source file may by synthesized using an automated design tool to create a net-list. The net-list may be used by an automated layout tool to create the circuit, which is preferably embodied in the graphics controller chip but which may be embodied in another ASIC. Alternatively, the net-list may be used by a device programmer to create a fuse-map that can be used to program a PLA, PLD, or other similar programmable chip to implement the circuit. The hardware definition language may be embodied in any machine readable medium such as a CDROM or floppy disk.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A graphics controller for interfacing between a host and a graphics display device for displaying pixels having pixel values, comprising a solarizing circuit having means for transforming an original pixel value to a transformed pixel value according to a transform function, said transform function having a negative slope at said original pixel value.

2. The graphics controller of claim 1, wherein said solarizing circuit further includes means for varying said slope.

3. The graphics controller of claim 2, wherein said solarizing circuit further includes memory means for storing one or more specifications sufficient for defining said slope.

4. The graphics controller of claim 1, wherein said transform function is piecewise linear.

5. The graphics controller of claim 4, wherein said transform function consists of two line segments.

6. The graphics controller of claim 5, wherein one of said two line segments has a positive slope.

7. The graphics controller of claim 6, wherein said positive slope substantially equals said negative slope.

8. The graphics controller of claim 6, wherein said positive slope is substantially not equal to said negative slope.

9. A solarizing circuit, comprising means for transforming an original pixel value to a transformed pixel value according to a transform function, said transform function having a negative slope at said original pixel value.

10. The solarizing circuit of claim 9, further comprising means for varying said slope.

11. The solarizing circuit of claim 10, further comprising memory means for storing one or more specifications sufficient for defining said slope.

12. The solarizing circuit of claim 9, wherein said transform function is piecewise linear.

13. The solarizing circuit of claim 12, wherein said transform function consists of two line segments and one of said two line segments has a positive slope.

14. A graphics display system, comprising:
a host;
a graphics display device for displaying pixels having pixel values; and
a graphics controller for interfacing between said host and said graphics display device, said graphics controller comprising a solarizing circuit having means for transforming an original pixel value to a transformed pixel value according to a transform function, said transform function having a negative slope at said original pixel value.

15. The system of claim 14, wherein said solarizing circuit further includes means for varying said slope.

16. The system of claim 15, wherein said solarizing circuit further includes memory means for storing one or more specifications sufficient for defining said slope.

17. The system of claim 14, wherein said transform function is piecewise linear.

18. The system of claim 17, wherein said transform function consists of two line segments.

19. The system of claim 18, wherein one of said two liner segments has a positive slope.

20. The system of claim 19, wherein said positive slope substantially equals said negative slope.
